(19) United States
(12) Patent Application Publication
(10) Pub. No.: US 2006/0003222 A1
(43) Pub. Date: Jan. 5, 2006

(54) Battery assembly

(76) Inventors: Takashi Mushiga, Osaka-shi (JP); Susumu Kato, Moriguchi-shi (JP); Kenji Yamamoto, Katano-shi (JP)

Correspondence Address: MCDERMOTT WILL & EMERY LLP, 600 13TH STREET, N.W., WASHINGTON, DC, 20005-3096, US

(21) Appl. No.: 11/167,909

(22) Filed: Jun. 28, 2005

(30) Foreign Application Priority Data
Jun. 30, 2004 (JP) 2004-194394

(51) Int. Cl. H01M 2/08

(52) U.S. Cl. 429/180; 429/184

(57) ABSTRACT

The battery assembly includes: an outer jacket for accommodating a plurality of cells, the outer jacket having an upper opening; and a terminal plate having a positive electrode terminal and a negative electrode terminal, the terminal plate closing the upper opening of the outer jacket. The terminal plate has a deflection temperature under load of 100 to 170° C.

### BACKGROUND OF THE INVENTION

The present invention relates to a battery assembly, and more particularly, to a terminal plate thereof.

A battery assembly is conventionally formed of a plurality of cells that are disposed with their sealing portions upward or downward, and a terminal plate and a spacer that are disposed on top of and under the cells, respectively. In such a battery assembly, even if the inner pressure of a cell rises to cause an increase in the force pushing up the sealing portion of the cell outward, the gasket fitted to the sealing portion of the cell does not become detached, since the cell is sandwiched between the terminal plate and the spacer. As a result, the contents of the cell are prevented from leaking out.

In order to enhance the safety of such a battery assembly, for example, Japanese Laid-Open Patent Publication No. 2002-15717 proposes a method of providing an auxiliary spacer between the cells and the terminal plate and/or between the cells and the space. This method increases the strength of the portions of the terminal plate corresponding to the sealing portions of the cells.

However, in the event of an internal short-circuit inside a cell or between cells and therefore an increase in cell temperature, the terminal plate may become softened. In this case, if the inner pressure of a cell rises, the softened terminal plate cannot hold the sealing portion of the cell, so that the gasket becomes detached from the sealing portion, which may result in leakage of cell contents.

It is therefore an object of the present invention to provide a battery assembly having high reliability even when the battery has a high temperature due to an external short-circuit or the like and thus the detachment of gaskets fitted to the sealing portions of cells thereof occurs, by preventing the softening of a terminal plate and thus the detachment of the terminal plate from a outer jacket.

### BRIEF SUMMARY OF THE INVENTION

A battery assembly according to the present invention includes: an outer jacket for accommodating a plurality of cells, the outer jacket having an upper opening; and a terminal plate having a positive electrode terminal and a negative electrode terminal, the terminal plate closing the upper opening of the outer jacket. The terminal plate has a deflection temperature under load of 100 to 170° C.

It is preferred that the terminal plate comprises a resin and a core material, that the resin be at least one selected from the group consisting of polypropylene, polycarbonate, and epoxy resin, and that the core material be at least one selected from the group consisting of glass fibers, calcium carbonate, talc, and polyethylene.

It is preferred that the resin be polypropylene, and that the core material be polyethylene.

It is preferred that the resin be polypropylene, and that the core material be talc.

It is preferred that the resin be polypropylene, and that the core material be calcium carbonate.

According to the present invention, even if the battery has a high temperature due to an external short-circuit or the like, the terminal plate does not get softened. Thus, even when the inner pressure of the cells increases due to the rising of battery temperature and the gaskets fitted to the sealing portions of the cells are detached, the terminal plate is not detached from the outer jacket and the contents of the cells do not leak out. It is therefore possible to obtain a battery assembly with high reliability.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing the structure of a battery assembly in accordance with the present invention; and

FIG. 2 is an exploded perspective view of the main part of the battery assembly of FIG. 1.

### DETAILED DESCRIPTION OF THE INVENTION

The present invention relates to a battery assembly including: an outer jacket for accommodating a plurality of cells, the outer jacket having an upper opening; and a terminal plate having a positive electrode terminal and a negative electrode terminal, the terminal plate closing the upper opening of the outer jacket. The present invention is characterized in that the terminal plate has a deflection temperature under load of 100 to 170° C.

The present inventors have made various examinations of terminal plate materials that do not get softened even when a battery has a high temperature. As a result, they have found that when a terminal plate is made of a material whose deflection temperature under load is 100% or higher, the terminal plate is resistant to deformation. That is, even if the temperature of a cell rises due to occurrence of an external short-circuit or the like, the terminal plate does not become softened, so that the terminal plate is not detached from the outer jacket, even if the gasket jumps out of the sealing portion of the cell, thereby preventing the contents of the cell from leaking out. It is preferred that the deflection temperature under load be higher in the above-mentioned range.

If the deflection temperature under load of a terminal plate is less than 100° C., the terminal plate is apt to become softened upon an increase in battery temperature. If the deflection temperature under load of a terminal plate exceeds 170° C., the terminal plate may have burrs when worked, or the terminal plate may become cracked.

The deflection temperature under load can be measured, for example, according to JIS K 7191 and ASTM-D648. The deflection temperature under load as used herein refers to the temperature at which the deflection of a member reaches standard deflection upon an increase in temperature.

The terminal plate comprises a resin such as polypropylene, polycarbonate, and epoxy resin.

Also, it is preferred that the terminal plate further contains a core material as filler, in order to improve its thermal resistance.

Preferably, the core material comprises an inorganic material, such as glass fibers, calcium carbonate, talc, or potassium titanate, or an organic material, such as polyethylene, a metal salt of benzoic acid, or a metal salt of phosphoric acid. These core materials can be used singly or in combination of two or more of them.

Among them, the core material is more preferably polyethylene in terms of improving the workability of the terminal plate. The core material is more preferably talc in terms of the ease of availability and because it produces the largest effect of increasing the deflection temperature under load. The core material is more preferably calcium carbonate, since it produces the second largest effect of increasing the deflection temperature under load, following talc.

The content of a core material in the terminal plate is preferably 15 to 40% by weight. If the content of a core material is less than 15% by weight, the effect of the core material becomes insufficient. On the other hand, if the content of a core material exceeds 40% by weight, the terminal plate becomes hard and brittle, so that it tends to become cracked when worked.

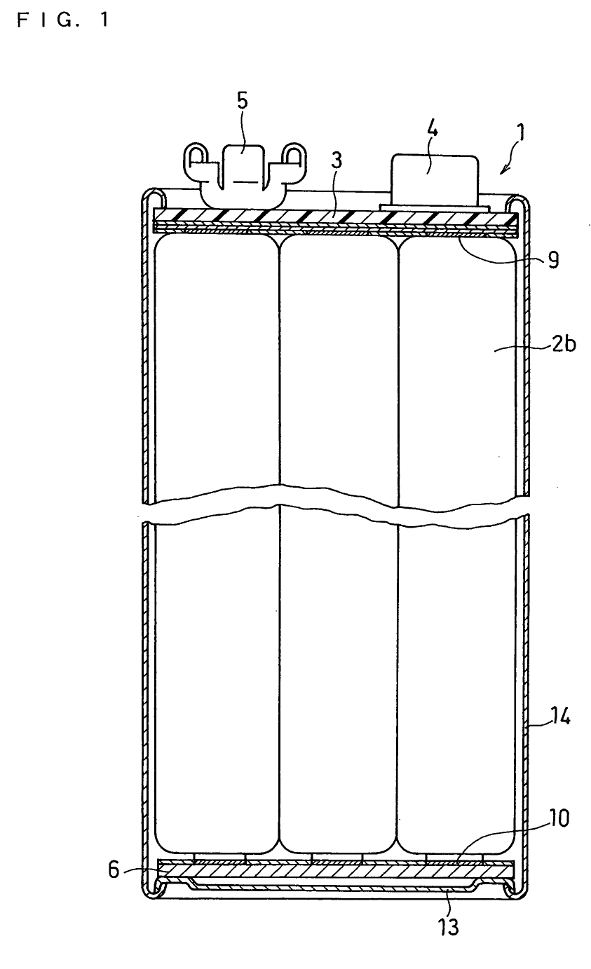

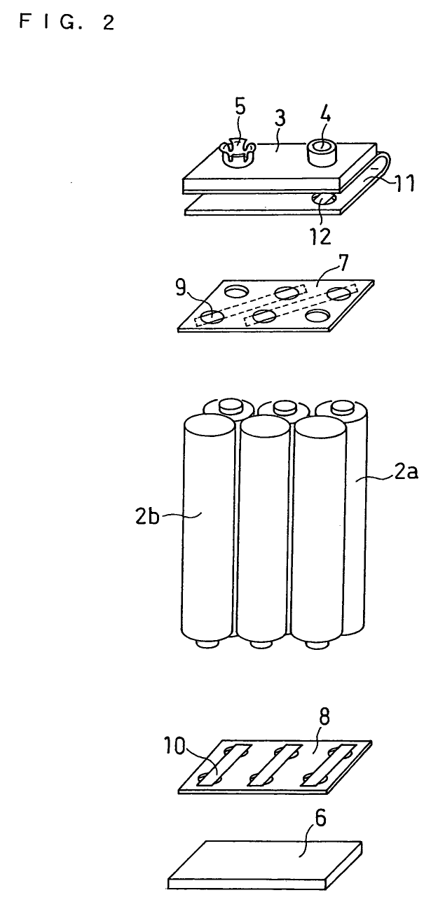

FIG. 1 is a schematic longitudinal sectional view of an alkaline dry battery 6LR61, which is an example of a battery assembly, and FIG. 2 is an exploded perspective view thereof.

The cell assembly constituting the alkaline dry battery 6LR61 comprises a first cell row 2a of three cells that are disposed with their sealing portions upward and a second cell row 2b of three cells that are disposed with their sealing portions downward, and the first cell row 2a and the second cell row 2b are connected in series.

Each of these cells is an alkaline dry battery in which power generating elements are contained in a cylindrical steel battery case with a bottom and the opening of the battery case is sealed with a nylon gasket having a negative electrode current collector and a negative electrode terminal plate. The cells are covered with a heat-shrinkable resin tube except for their upper and lower terminals. The cell assembly is contained in an outer jacket 14.

An upper connection plate comprising an insulating paper 7 is disposed on top of the cell assembly. The insulating paper 7 has through-holes at the parts corresponding to the upper terminals of the respective cells, and it also has two leads 9 that are affixed under the through-holes for connecting the cells of the first cell row 2a and the cells of the second cell row 2b in series. The two leads 9 are spot-welded to the terminals of the cells at the through-holes of the insulating paper 7.

A lower connection plate comprising an insulating paper 8 is disposed under the cell assembly. The insulating paper 8 has through-holes at the parts corresponding to the lower terminals of the respective cells, and it also has three leads 10 that are affixed over the through-holes for connecting the cells of the first cell row 2a and the cells of the second cell row 2b in series. The three leads 9 are spot-welded to the terminals of the cells at the through-holes of the insulating paper 8. A spacer 6 is disposed under the lower connection plate comprising the insulating paper 8.

The upper part of the outer jacket 14 is sealed with a terminal plate 3, which is made of a synthetic resin and has a positive output terminal 4 and a negative output terminal 5. The terminal plate 3 is the above-described terminal plate of the present invention. To the lower face of the terminal plate 3 is riveted an insulating paper 11, a positive electrode lead 12 and a negative electrode lead (not shown). These terminals and the corresponding leads are connected with rivets.

The end of the lead 12 connected to the positive output terminal 4 of the terminal plate 3 is connected to the positive electrode terminal of the far-right cell of the second cell row 2b in FIG. 2 at the corresponding through-hole of the insulating paper 11. Likewise, the lead connected to the negative output terminal 5 is connected to the negative electrode terminal of the far-left cell of the first cell row 2a in FIG. 2 at the corresponding through-hole of the insulating paper 11. In this way, six cells are connected in series, so that an output can be taken out from the positive output terminal 4 and the negative output terminal 5.

When the cells are alkaline dry batteries (LR61) with a small outer diameter, it is difficult to provide their gaskets with a highly reliable explosion-proof mechanism. In order to prevent the explosion of such a cell, the cell is constructed such that upon an increase in inner pressure due to gas or steam production inside the cell, the nylon gasket becomes a little detached from the iron case, thereby decreasing the inner pressure. Also, in order to prevent the gasket from jumping out and completely becoming detached from the cell, the cell is held and sandwiched between the terminal plate and the spacer, so that the contents of the cell do not leak out and only the gas can be discharged to outside.

Further, when the terminal plate of the present invention is used as the terminal plate 3, the terminal plate does not get softened even upon an increase in battery temperature due to an internal short-circuit. Accordingly, it is possible to obtain a highly reliable battery assembly in which the gaskets of their cells do not become detached even in the event of an internal short-circuit.

### EXAMPLES 1 to 6 and COMPARATIVE EXAMPLE 1

As shown in Table 1, terminal plates were obtained by molding a mixture of a resin and a core material into a predetermined shape. The content of the core material in the terminal plate was made 30% by weight. Also, these terminal plates had the same shape and a thickness of 1.0 mm.

TABLE 1

| | | | | The number |
|---|---|---|---|---|
| | | | | of battery |
| | | | Deflection | assemblies |
| | | | temperature | with |
| | | Core | under load | detached |
| | Resin | material | (° C.) | gasket |
| Comparative | Poly(vinyl | None | 80 | 3 |
| Example 1 | chloride) | | | |
| Example 1 | Polypropylene | None | 114 | 0 |
| Example 2 | Polypropylene | Polyethylene | 104 | 0 |
| Example 3 | Polypropylene | Calcium | 134 | 0 |
| | | carbonate | | |
| Example 4 | Polypropylene | Talc | 142 | 0 |
| Example 5 | Polycarbonate | None | 130 | 0 |
| Example 6 | Epoxy resin | Glass fibers | 168 | 0 |

Using the terminal plates thus obtained, battery assemblies as illustrated in FIGS. 1 and 2 were produced.

[Evaluation]

(1) Measurement of Deflection Temperature under Load of Terminal Plate

The deflection temperature under loads of the respective terminal plates were measured according to JIS K 7191. It should be noted that the average value of five measurements was used as the deflection temperature under load of a terminal plate.

(2) Short-Circuit Test

10 battery assemblies each were prepared. Under a room temperature environment, these battery assemblies were caused to short by connecting the positive electrode terminals and the negative electrode terminals of two batteries. At this time, the battery temperature increased, and the temperature of the battery surface and the temperature of the terminal plate were 102° C. The number of battery assemblies that exhibited leakage of contents due to detachment of a gasket was counted. Table 1 shows the results.

In Comparative Example 1, some battery assemblies exhibited leakage of contents due to detachment of a gasket. However, in Examples 1 to 6, none of the battery assemblies exhibited leakage of contents due to detachment of a gasket, and the battery assemblies had high reliability. The battery reliability was improved particularly when the deflection temperature under load of the terminal plate was not less than 130° C., and the higher the deflection temperature under load was, the greater the improvement was.

The battery assembly with high reliability according to the present invention is applicable, for example, to a power source for an electronic device.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A battery assembly comprising: an outer jacket for accommodating a plurality of cells, said outer jacket having an upper opening; and a terminal plate having a positive electrode terminal and a negative electrode terminal, said terminal plate closing the upper opening of said outer jacket, wherein said terminal plate has a deflection temperature under load of 100 to 170° C.

2. The battery assembly in accordance with claim 1, wherein said terminal plate comprises a resin and a core material, said resin is at least one selected from the group consisting of polypropylene, polycarbonate, and epoxy resin, and said core material is at least one selected from the group consisting of glass fibers, calcium carbonate, talc, and polyethylene.

3. The battery assembly in accordance with claim 2, wherein said resin is polypropylene, and said core material is polyethylene.

4. The battery assembly in accordance with claim 2, wherein said resin is polypropylene, and said core material is talc.

5. The battery assembly in accordance with claim 2, wherein said resin is polypropylene, and said core material is calcium carbonate.
